(19) United States
(12) Patent Application Publication
(10) Pub. No.: US 2012/0165991 A1
(43) Pub. Date: Jun. 28, 2012

(54) SYSTEM AND METHOD FOR CONTROLLING HUMIDITY OF A SERVER

(75) Inventors: BO TIAN, Shenzhen City (CN); KANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/081,503

(22) Filed: Apr. 7, 2011

(30) Foreign Application Priority Data
Dec. 24, 2010 (CN) 201010605128.2

(51) Int. Cl. G05D 23/19

(52) U.S. Cl. 700/276

(57) ABSTRACT

A humidity control system and method controls humidity in a server by acquiring a humidity value inside of the server using a humidity detector of the server at a predetermined time interval. The method further includes disabling a dehumidifier of the server to dehumidify the inside of the server, upon the condition that the acquired humidity value is greater than a predetermined first threshold value.

### BACKGROUND

1. Technical Field

Embodiments of the present disclosure relate to control systems and methods, and in particular, to a system and method for controlling humidity of a server.

2. Description of Related Art

A server (e.g., a host computer) may be connected to a plurality of accessories and external devices. Therefore, the server may be sensitive to humidity. If the humidity in the server is too high, performance and life of some of the accessories or the external devices connected to the server may be affected, thus, the performance and the life of the server also may be affected. Therefore, a system and method for controlling the humidity of the server is desired.

### BRIEF DESCRIPTION OF THE DRAWINGS

FIG. 1 is a schematic diagram of one embodiment of a server including a humidity controlling system.

FIG. 2 is a block diagram of one embodiment of the humidity controlling system of FIG. 1.

FIG. 3 is a flowchart of one embodiment of a method of controlling humidity of a server, such as, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

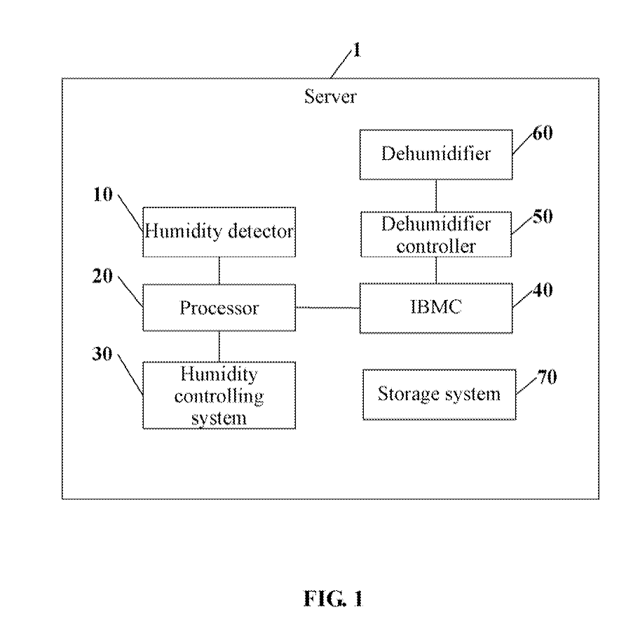

FIG. 1 is a schematic diagram of one embodiment of a server 1 including a humidity controlling system 30. The server 1 also includes a humidity detector 10, a processor 20, an integrated baseboard management controller (IBMC) 40, a dehumidifier controller 50 and a dehumidifier 60. In some embodiments, the server 1 may be a computer or any computing device. The humidity controlling system 30 may detect humidity of the server 1 using the humidity detector 10, and control the humidity of the server 1 to within an allowable range to protect the server 1.

The humidity detector 10 includes at least two humidity sensors to detect the humidity values of inside of the server 1. The humidity sensors can be installed on the top and bottom of a motherboard (not shown in FIG. 1) of the server 1. The processor 20 is in communication with the humidity detector 10, to read detected humidity values from the humidity detector 10. The processor 20 executes one or more computerized codes of the server 1 and other applications. The IBMC 40 is connected to the processor 20 through General Purpose Input/Output (GPIO) interfaces (not shown in FIG. 1), to receive trigger signals from the processor 20. The trigger signal may be a high-level signal or a low-level signal e.g., logic 1 and 0, respectively).

The IBMC 40 also communicates with the dehumidifier controller 50 through the GPIO interfaces, to send a predetermined start command or a predetermined end command to the dehumidifier controller 50. If the dehumidifier controller 50 has received the predetermined start command, the dehumidifier controller 50 may enable the dehumidifier 60 by providing power supply to the dehumidifier 60. If the dehumidifier controller 50 has received the predetermined end command, the dehumidifier controller 50 may disable the dehumidifier 60 by cutting off the power supply to the dehumidifier 60. Disabling the dehumidifier 60 represents shutting down the dehumidifier 60. In some embodiments, initially, the dehumidifier controller 50 may not provide the power supply to the dehumidifier 60 to save power until it receives the predetermined start command. The dehumidifier 60 may be installed on the motherboard of the server 1. The dehumidifier 60 communicates with the dehumidifier controller 50, to dehumidify the inside of the server 1. The dehumidifier 60 may be replaced if the dehumidifier 60 is damaged.

The server 1 further includes a storage system 70. The storage system 70 may store various data of the server 1. The storage system 70 may be a memory of the server 1, or an external storage card, such as a smart media (SM) card, or a secure digital (SD) card.

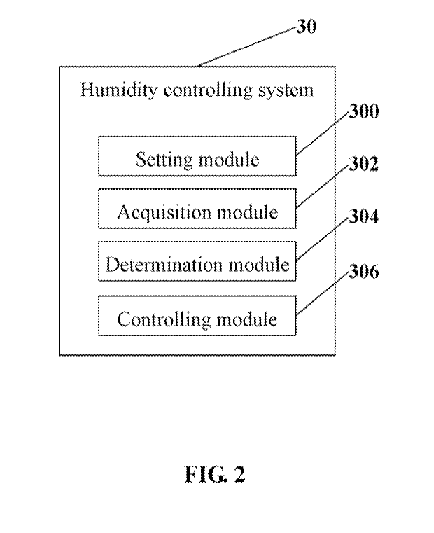

FIG. 2 is a block diagram of one embodiment of the humidity controlling system 30 of FIG. 1. In some embodiments, the humidity controlling system 30 includes a setting module 300, an acquisition module 302, a determination module 304, and a controlling module 306. The modules 300, 302, 304, and 306 comprise computerized codes in the form of one or more programs that are stored in the storage system 70. The computerized code includes instructions that are executed by the processor 20 to provide functions for modules 300, 302, 304, and 306. Details of these operations follow.

The setting module 300 sets a first threshold value, and a second threshold value of the server 1. The first threshold value and the second threshold value are used to compare with the humidity value of the server 1, and to determine if the server 1 needs to be dehumidified. The first threshold value is greater than the second threshold value. In some embodiments, the first threshold value may be set to be 45% relative humidity (RH), and the second threshold may be set to be 25% RH.

The acquisition module 302 acquires a humidity value of the inside of the server 1 from a humidity detector 10 at a predetermined time interval through the processor 20. For example, the predetermined time interval may be 25 seconds.

The determination module 304 determines whether the acquired humidity value is greater than the first threshold value.

If the acquired humidity value is greater than the first threshold value, the controlling module 306 sends a starting signal to the IBMC 40 through the processor 20, to control the IBMC 40 to send the predetermined start command to the dehumidifier controller 50, to enable the dehumidifier 60. In some embodiments, the starting signal may be a high-level (e.g., 1V) signal. The dehumidifier controller 50 may provide the power supply to the dehumidifier 60, and the dehumidifier 60 begins to dehumidify the inside of the server 1.

The determination module 302 further determines whether the acquired humidity value is less than the second threshold value when the dehumidifier 60 is enabled.

If the acquired humidity value is less than the second threshold value, the controlling module 306 further sends an ending signal to the IBMC 40 through the processor 20, to control the IBMC 40 to send the predetermined end command to the dehumidifier controller 50, to disable the dehumidifier 60. In some embodiments, the ending signal may be a low-level (e.g., 0V) signal. The dehumidifier controller 50 may cut off the power supply to the dehumidifier 60, and the dehumidifier 60 stop dehumidifying the inside of the server 1.

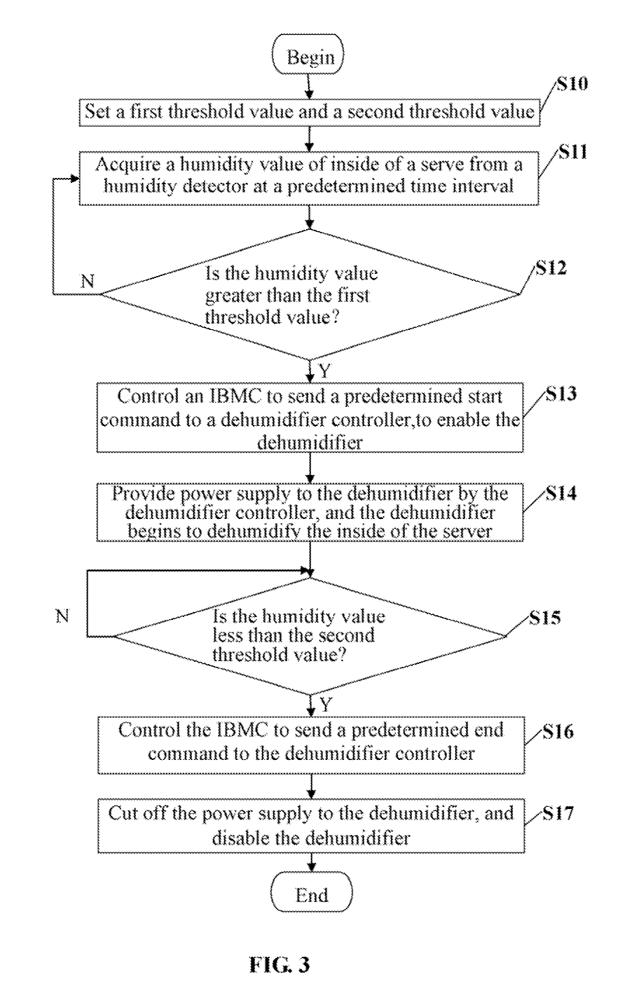

FIG. 3 is a flowchart of one embodiment of a method of controlling humidity of a server, such as, that of FIG. 1. Depending on the embodiment, additional blocks may be added, others removed, and the ordering of the blocks may be changed.

In block S10, the setting module 300 sets a first threshold value, a second threshold value of the server 1. The first threshold value is greater than the second threshold value.

In block S11, the acquisition module 302 acquires a humidity value from inside of the server 1 with a humidity detector 10 at a predetermined time interval through the processor 20. In some embodiments, the predetermined time interval may be 25 seconds.

In block S11, the determination module 304 determines whether the acquired humidity value is greater than the first threshold value. If the acquired humidity value is less than or equal to the first threshold value, the block S11 is repeated.

If the acquired humidity value is greater than the first threshold value, in block S13, the controlling module 306 sends a starting signal to the IBMC 40 through the processor 20, to control the IBMC 40 to send the predetermined start command to the dehumidifier controller 50, to enable the dehumidifier 60.

In block S14, the dehumidifier controller 50 provides the power supply to the dehumidifier 60, and the dehumidifier 60 begins to dehumidify the inside of the server 1.

In block S15, the determination module 302 further determines whether the acquired humidity value is less than the second threshold value, upon the condition that the dehumidifier is enabled. If the acquired humidity value is lager than or equal to the second threshold value, the block S15 is repeated.

If the acquired humidity value is less than the second threshold value, in block S16, the controlling module 306 sends an end signal to the IBMC 40 through the processor 20, to control the IBMC 40 to send the predetermined end command to the dehumidifier controller 50, to disable the dehumidifier 60.

In block S17, the dehumidifier controller 50 may cut off the power supply to the dehumidifier 60, and the dehumidifier 60 stops dehumidifying the inside of the server 1.

It should be emphasized that the described exemplary embodiments are merely possible examples of implementations, and set forth for a clear understanding of the principles of the present disclosure. Many variations and modifications may be made to the-described exemplary embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. A computer-implemented method of controlling humidity of a server, the method comprising:
acquiring a humidity value of inside of the server from a humidity detector of the server at a predetermined time interval; and
enabling a dehumidifier of the server to dehumidify the inside of the server, upon the condition that the acquired humidity value is greater than a predetermined first threshold value.

2. The method as claimed in claim 1, wherein the method further comprises:
setting a second threshold value that is less than the first threshold value;
determining whether the acquired humidity value is less than the second threshold value, upon the condition that the dehumidifier is enabled; and
disabling the dehumidifier, upon the condition that the acquired humidity value is less than the second threshold value.

3. The method as claimed in claim 2, wherein the server further comprises a dehumidifier controller and a integrated baseboard management controller (IBMC).

4. The method as claimed in claim 3, wherein the method further comprises:
controlling the IBMC to send a predetermined start command to the dehumidifier controller, and the dehumidifier controller enables the dehumidifier according to the predetermined start command.

5. The method as claimed in claim 3, wherein the method further comprises:
controlling the IBMC to send a predetermined end command to the dehumidifier controller, and the dehumidifier controller disables the dehumidifier according to the predetermined end command.

6. The method as claimed in claim 3, wherein the humidity detector is in communication with a processor, and installed on a motherboard of the server, the dehumidifier is in communication with the dehumidifier controller and installed on the motherboard of the server, and the dehumidifier controller connects to the processor through basic input/output interfaces of the IBMC.

7. A storage medium storing a set of instructions, the set of instructions capable of executed by a processor to perform a method of controlling humidity of a server, the method comprising:
acquiring a humidity value of inside of the serve from a humidity detector of the server at a predetermined time interval; and
enabling a dehumidifier of the server to dehumidify the inside of the server, upon the condition that the acquired humidity value is greater than a predetermined first threshold value.

8. The storage medium as claimed in claim 6, wherein the method further comprises:
setting a second threshold value that is less than the first threshold value;
determining whether the acquired humidity value is less than the second threshold value, upon the condition that the dehumidifier is started; and
disabling the dehumidifier, upon the condition that the acquired humidity value is less than the second threshold value.

9. The storage medium as claimed in claim 8, wherein the server further comprises a dehumidifier controller and a integrated baseboard management controller (IBMC).

10. The storage medium as claimed in claim 9, wherein the method further comprises:
controlling the IBMC to send a predetermined start command to the dehumidifier controller, and the dehumidifier controller enables the dehumidifier according to the predetermined start command.

11. The storage medium as claimed in claim 9, wherein the method further comprises:
controlling the IBMC to send a predetermined end command to the dehumidifier controller, and the dehumidifier controller disables the dehumidifier according to the predetermined end command.

12. The storage medium as claimed in claim 9, wherein the humidity detector is in communication with the processor, and installed on a motherboard of the server, the dehumidifier is in communication with the dehumidifier controller and installed on the motherboard of the server, and the dehumidifier controller connects to the processor through basic input/output interfaces of the IBMC.

13. A server, comprising:
a storage system;
a humidity detector;
a dehumidifier;
a processor; and
one or more programs stored in the storage system, executable by the processor, the one or more programs comprising:
an acquisition module operable to acquire a humidity value of inside of the server from the humidity detector at a predetermined time interval; and
a controlling module operable to enable the dehumidifier to dehumidify the inside of the server, upon the condition that the acquired humidity value is greater than a predetermined first threshold value.

14. The server as claimed in claim 13, wherein the setting module further operable to set a second threshold value less than the first threshold value;
a determination module operable to determine whether the acquired humidity value is less than the second threshold value, upon the condition that the dehumidifier is enabled; and the controlling module further operable to shut down the dehumidifier, upon the condition that the acquired humidity value is less than the second threshold value.

15. The server as claimed in claim 14, wherein the server further comprises a dehumidifier controller and a integrated baseboard management controller (IBMC).

16. The server as claimed in claim 15, wherein the controlling module further operable to control the IBMC to send a predetermined start command to the dehumidifier controller through the processor, and the dehumidifier controller enables the dehumidifier according to the predetermined start command.

17. The server as claimed in claim 15, wherein the controlling module further operable to control the IBMC to send a predetermined end command to the dehumidifier controller through the processor, and the dehumidifier controller disables the dehumidifier according to the predetermined end command.

18. The server as claimed in claim 15, wherein the humidity detector is in communication with the processor, and installed on a motherboard of the server, the dehumidifier is in communication with the dehumidifier controller and installed on the motherboard of the server, and the dehumidifier controller connects to the processor through basic input/output interfaces of the IBMC.
